(19) United States
(12) Patent Application Publication
(10) Pub. No.: US 2018/0297526 A1
(43) Pub. Date: Oct. 18, 2018

(54) INTERIOR MIRROR BASE ASSEMBLY

(71) Applicant: Magna Mirrors Holding GmbH, Sailauf (DE)

(72) Inventors: Stephan Hennig, Bessenbach (DE); Robert Weimer, Hösbach (DE)

(21) Appl. No.: 15/768,095

(22) PCT Filed: Sep. 26, 2016
(86) PCT No.: PCT/EP2016/072863

§ 371 Date: Apr. 13, 2018

(30) Foreign Application Priority Data
Oct. 22, 2015 (DE) 10 2015 220 706.4

(51) Int. Cl. B60R 1/04; B60R 1/12

(52) U.S. Cl. CPC B60R 1/04; B60R 2011/0026; B60R 2001/1223; B60R 1/12

(57) ABSTRACT

A mounting base assembly includes at least one mounting, a mounting base and a designated space for accommodating sensors, wherein the mounting plate is to be fitted to a window of a motor vehicle and the mounting base can be connected to the mounting plate via a fastening bracket, wherein the mounting base or the mounting plate has a locking element which prevents the two components from moving in the unlocking direction.

The invention relates to a mounting base assembly for a motor vehicle in accordance with the preamble of claim 1.

### PRIOR ART

Mounting base assemblies, such as interior mirror base assemblies, are known from the prior art and are formed from a mounting plate, a mounting base and mounting brackets. Sensors are also incorporated in some cases.

A sensor is also provided in DE 299 06 013 U1 and can be pressed against the windshield by the mirror base. The pressing force for the sensor is provided by a leaf spring inserted into the sensor housing, whereas the latching between the mirror base and the mounting plate is effected by a clamping/retaining element.

Correspondingly, the mounting of such a device has to be effected both against the spring force of the clamping/retaining element and against the spring force of the leaf spring. Overall, mounting is made more difficult as a result.

The interior mirror assembly proposed in DE 698 26 101 T2 has a housing for a sensor. The housing is directly connected to the windshield. The sensor is fitted together with a biasing element in the housing, which biasing element presses the sensor against the windshield. The mirror base is fastened directly to the housing. It is necessary here to carry out at least two mounting operations to fit the interior mirror assembly.

DE 100 60 447 B4 has disclosed an interior mirror assembly which allows a connection of the mirror base and the pressing-on of the sensor in one operation, in particular since there is provided here a resilient U-shaped fastening bracket which is designed both for receiving the sensor and, by way of its latching members fitted on the end sides, for fastening to a mounting plate. However, in terms of the dimensions, in particular in terms of the height of the sensor, the interior mirror assembly proposed here can be used to only a very limited degree since a connection between the mirror base and window assembly will no longer be able to be established if the sensor is of only slightly different configuration.

DE102008011871 A1 discloses an interior mirror assembly, wherein a pressing and locking means can be introduced between the mounting plate and the mirror base and is designed to lock the mirror base with respect to the mounting plate and to press the sensor incorporated there in the direction of the window connection. The connection between the mounting plate and the mirror base and a pressing of the sensor against the window of a motor vehicle can be performed in a single mounting step. However, the mounting principle is multistage. The mirror base is fastened to the mounting plate by a fastening bracket, and the sensor is pressed on by spring clamps and a plastic clip. The actual fastening between the mounting plate and mirror base is constituted by the fastening bracket which extends approximately perpendicularly to the window of the vehicle. For system-related reasons, this u-shaped fastening bracket can be locked only so hard as the force of the fitter allows. Unlocking of the system is possible by pressing counter to the mounting direction. That is in particular a disadvantage when the interior mirror unlocks and slips out of the mounting plate due to the centrifugal forces in a vehicle crash. Instead of using a simple interior mirror, use has been made in the meantime of complex interior mirror devices with electronic components, sensors and indicators. Here, these interior mirror devices have a mirror glass or are already equipped with displays which replace the pure mirror glass.

In this context, the term “mounting base assembly” in the text below is understood in the very broad sense and is not limited to the conventional interior mirror. The term “mirror” is used for example for a component which can be fastened at the interior mirror position.

It is an object of the present invention to propose a mounting base assembly which allows simple mounting of the mounting base assembly and is designed to be accident-proof but releasable in a simple manner.

According to the invention, this object is achieved by a mounting base assembly, comprising at least one mounting plate, a mounting base and, where appropriate, a designated space for accommodating electronic components, wherein the mounting plate is to be fitted to a window of a motor vehicle and the mounting base can be connected to the mounting plate via a fastening bracket, wherein the mounting base or the mounting plate has a locking element which prevents the two components from moving in the unlocking direction.

The resilient element, which is independent of the actual fastening bracket, locks or blocks counter to the mounting direction in order to prevent the mirror from detaching under high impact forces.

Here, it is advantageous for the locking element to have a device for releasing the locking so that the mirror can also be nondestructively demounted again.

The locking element advantageously comprises at least one spring tongue with an extension in order to ensure the dual function of blocking and unlocking.

The locking element is either formed and mounted in one piece with the fastening bracket or separately from the fastening bracket.

Unlocking of the entire system is thus only possible if the fastening bracket is unlocked and in particular the locking is additionally released.

### DESCRIPTION OF THE INVENTION

The invention is described hereinbelow by way of example with reference to the appended drawing.

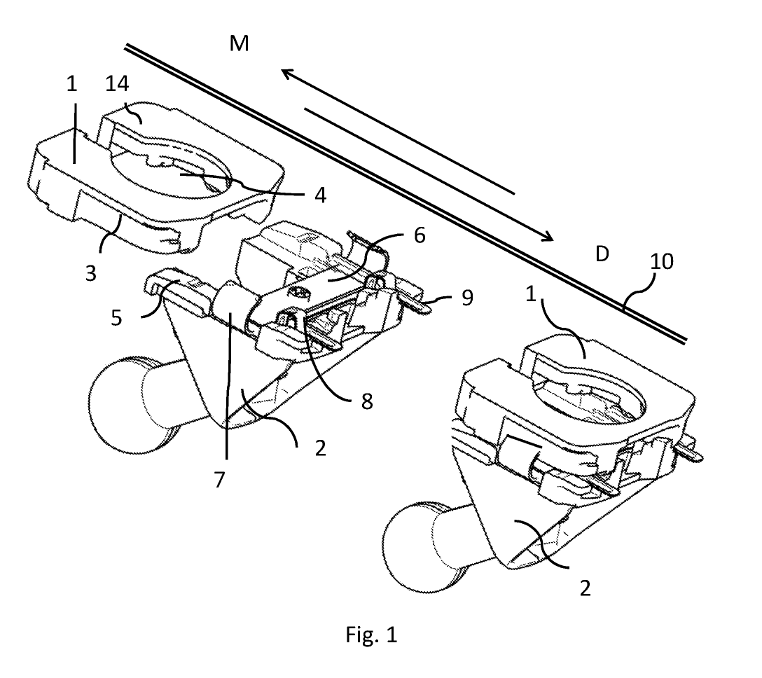

FIG. 1 shows a schematic illustration of the exemplary embodiment in a separated and mounted position.

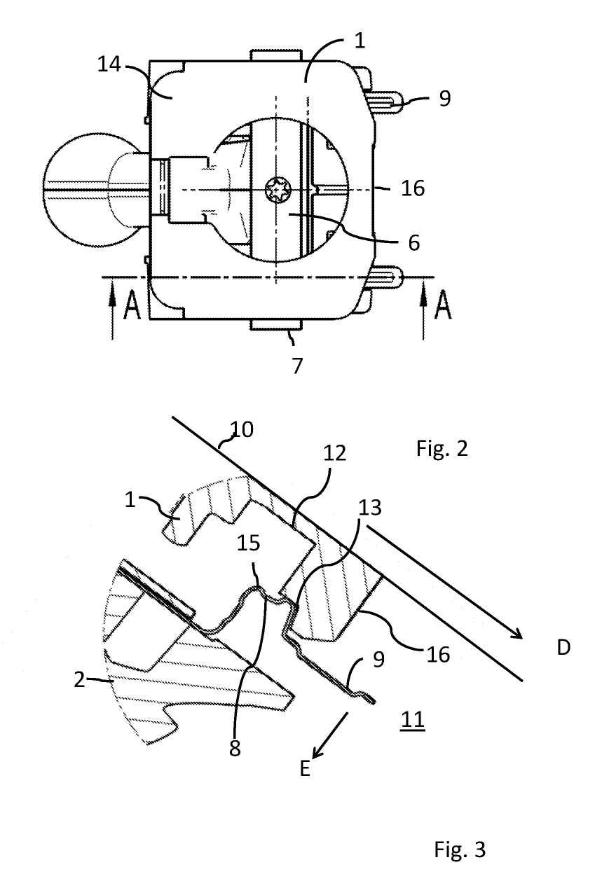

FIG. 2 shows a plan view of the mounting plate.

FIG. 3 shows a section along A-A in detail.

FIG. 1 illustrates the two components of the interior mirror base assembly or mounting base assembly. On the left side of the figure, the components are still separated from one another, while on the right side of the figure they can be seen in the mounted state. A mounting plate 1 has a circular opening 4 and is pressed and normally adhesively bonded against the surface of a vehicle window 10 by its outer side, the plane 14. Along its outer edge, the mounting plate has a latching region 3 which is set back with respect to the remaining edge of the mounting plate 1.

The mounting base 2 has an edge 5 along its two sides extending in the mounting direction. A fastening bracket 6 is fitted perpendicular to the edge 5. In this exemplary embodiment, the fastening bracket is screwed centrally. The fastening bracket terminates in its longitudinal extent in a respective lug 7. Emanating from the fastening bracket 6 there extend two spring tongues 8 perpendicular to the longitudinal direction of the fastening bracket 6, which tongues terminate in extensions 9. The spring tongues 8 and the extensions 9 form part of a locking element 11. In the example, the two spring tongues 8 are fitted along the edge 5 of the mounting base.

The mounting base 2 has a designated space which offers a receptacle for different electronic components. Through the opening 4 of the mounting plate 1 it is possible for sensors or transmitters to receive information from outside through the window 10 or transmit information through said window. If the mounting plate 1 is fitted to the window 10, the mounting base 2 is pushed onto the mounting plate 1 in the mounting direction M and fastening brackets are pressed on in the latching region. It can be seen on the right side of FIG. 1 how the lug 7 engages in the latching region 3. Here, the configuration of the latching arrangement and the mounting with a fastening bracket is left to a person skilled in the art. In this respect, a number of proposals are known from the prior art.

Without further measures, such a mounted mounting base assembly would be separated again into individual components in the demounting direction D by a force counter to the mounting direction M.

The locking element 11 acts against this. FIG. 2 depicts a plan view of the mounting plate 1 from above, that is to say from outside through the vehicle window. The mounting bracket 6 can be seen through the opening 4 of the mounting plate, with the mounting bracket being fastened to the mounting base by a central screw. In the plan view, the end of the lugs 7 can be seen on both sides of the mounting plate. The extensions 9, which project beyond the mounting plate and the boundary 16 thereof, can be seen on the right side. Their function is illustrated in more detail in FIG. 3.

FIG. 3 illustrates the right side of the section A-A. The mounting plate 1 shows an inner contour 12 which forms a bearing surface 13 for the spring tongue 8. The inner contour with the bearing surface forms the second part of the locking element. The spring tongue 8 is formed with a double hump 15 which transitions into the extension 9. The extension 9 projects beyond the mounting base arrangement between the mounting plate 1 and mounting base 2. Since the spring tongue bears against the bearing surface 13 by its humps 15, simple demounting along the direction D is not possible. For unlocking along the demounting direction D, the extension 9 has to be pressed in the direction of the mounting base 2, that is to say in the unlocking direction E, with the result that the spring tongue 8 is released from the bearing surface 13 and allows a movement of the mounting base 2 with respect to the mounting plate 1.

In this exemplary embodiment, the spring tongue 8 is produced directly with the fastening bracket 6 from one component in spring steel.

Depending on how strong the locking is intended to be, there is provision to have one or more spring tongues. As an alternative to the one-piece configuration, the spring tongues can also be fitted in the mounting base independently of the fastening bracket.

In a further alternative embodiment, the spring tongues 8 are fitted in the mounting plate, whereas the mounting base has the necessary inner contour with bearing surface.

The invention is not limited to the fastening of a conventional interior mirror; it is also suitable for holding a display, a camera, a combination of the two and further electronic components.

### LIST OF REFERENCE SIGNS

1 Mounting plate

2 Mounting base

3 Latching region

4 Opening

5 Mounting base edge

6 Fastening bracket

7 Lug

8 Spring tongue

9 Actuating means

10 Window

11 Locking element

12 Inner contour

13 Bearing surface

14 Plane

15 Hump

16 Boundary

M Mounting direction

D Demounting direction

E Unlocking direction

1. A mounting base assembly comprising at least one mounting plate, a mounting base and, where appropriate, a designated space for accommodating electronic components, wherein the mounting plate is configured to be fitted to a window of a motor vehicle and the mounting base is configured to be connected to the mounting plate via a fastening bracket, and wherein the mounting base or the mounting plate has a locking element, which, when the mounting base is connected, via the fastening bracket, to the mounting plate fitted to the window prevents the two components from moving in a demounting direction.

2. The mounting base assembly as claimed in claim 1, wherein the locking element has a device for releasing the locking.

3. The mounting base assembly as claimed in claim 2, wherein the locking element comprises at least one spring tongue with an extension.

4. The mounting base assembly as claimed in claim 3, wherein the extension projects beyond the boundary of the components.

5. The mounting base assembly as claimed in claim 3, wherein the locking element additionally comprises an inner contour with a bearing surface against which the spring tongue is supported.

6. The mounting base assembly as claimed in claim 5, wherein the locking element is formed in one piece with the fastening bracket.

7. The mounting base assembly as claimed in claim 5, wherein the locking element is formed and mounted separately from the fastening bracket.

8. The mounting base assembly as claimed in claim 4, wherein the locking element is formed and mounted separately from the fastening bracket.

9. The mounting base assembly as claimed in claim 4, wherein the locking element is formed in one piece with the fastening bracket.

10. The mounting base assembly as claimed in claim 1, wherein the locking element is formed and mounted separately from the fastening bracket.

11. The mounting base assembly as claimed in claim 1, wherein the locking element is formed in one piece with the fastening bracket.

12. The mounting base assembly as claimed in claim 2, wherein the extension projects beyond the boundary of the components.

13. The mounting base assembly as claimed in claim 1, wherein the extension projects beyond the boundary of the components.

14. The mounting base assembly as claimed in claim 1, wherein the locking element comprises at least one spring tongue with an extension.

15. A mounting base assembly for an interior mirror assembly for a vehicle, the mounting base assembly comprising:
a mounting plate configured to attach at a window of a motor vehicle;
a mounting base configured to connect to the mounting plate via a fastening bracket;
a space for accommodating at least one electronic component at the windshield;
a locking element;
wherein, when the mounting base is connected, via the fastening bracket, to the mounting plate attached at the window, the locking element prevents movement of the mounting base relative to the mounting plate in a demounting direction;
wherein the fastening bracket is attached to one of the mounting plate and the mounting base, and wherein the locking element comprises a spring element that is part of the fastening bracket and is biased toward engagement with the other of the mounting base and the mounting plate; and
wherein the spring element has a tab that extends from the mounting base and the mounting plate configuration when the mounting base is connected to the mounting plate, and wherein movement of the tab in a direction opposite its biased direction unlocks the locking element to allow for movement of the mounting base relative to the mounting plate in the demounting direction.

16. The mounting base assembly as claimed in claim 15, wherein the locking element comprises an inner contour of the other of the mounting base and the mounting plate, and wherein the inner contour has a bearing surface against which the spring element engages when locking the mounting base relative to the mounting plate.

17. The mounting base assembly as claimed in claim 15, wherein the locking element is formed in one piece with the fastening bracket.

18. The mounting base assembly as claimed in claim 15, wherein the locking element is formed and mounted separately from the fastening bracket.

19. A mounting base assembly for an interior mirror assembly for a vehicle, the mounting base assembly comprising:
a mounting plate configured to attach at a window of a motor vehicle;
a mounting base configured to connect to the mounting plate via a fastening bracket;
wherein the fastening bracket is attached at the mounting base and comprises at least one spring element extending therefrom;
wherein the mounting plate and the mounting base provide a space for accommodating at least one electronic component at the windshield;
wherein, when the mounting base is connected, via the fastening bracket, to the mounting plate attached at the window, the spring element is biased toward engagement with the an engaging surface of the mounting plate;
wherein, when the mounting base is connected, via the fastening bracket, to the mounting plate attached at the window, the spring element engages the engaging surface of the mounting plate to limit movement of the mounting base relative to the mounting plate in a demounting direction; and
wherein the spring element has a tab that extends from the mounting base and the mounting plate configuration when the mounting base is connected to the mounting plate, and wherein movement of the tab in a direction opposite its biased direction disengages the spring element from the engaging surface of the mounting plate to allow for movement of the mounting base relative to the mounting plate in the demounting direction.

20. The mounting base assembly as claimed in claim 19, wherein the locking element is formed in one piece with the fastening bracket.
